(19) United States
(12) Patent Application Publication
(10) Pub. No.: US 2017/0295339 A1
(43) Pub. Date: Oct. 12, 2017

(54) IMAGING DEVICE, IMAGING METHOD, AND IMAGING PROGRAM

(71) Applicant: JVC KENWOOD Corporation, Yokohama-shi (JP)

(72) Inventors: Takeshi IBARAKI, Yokohama-shi (JP); Kazutaka SHIOTA, Yokohama-shi (JP)

(73) Assignee: JVC KENWOOD Corporation, Yokohama-shi (JP)

(21) Appl. No.: 15/460,406

(22) Filed: Mar. 16, 2017

(30) Foreign Application Priority Data
Apr. 6, 2016 (JP) 2016-076591

(51) Int. Cl. H04N 5/38; G06K 9/46; H04N 19/426; H04N 7/01

(52) U.S. Cl. CPC H04N 5/38; H04N 7/012; H04N 7/0127; G06K 9/4671; H04N 19/426; G06K 2009/4666

(57) ABSTRACT

A discrete-type imaging device includes a camera head and a camera control unit, and video shot by the camera head is transmitted to the camera control unit via a plurality of transmission lines. A temperature sensor measures a temperature of the camera head. A high-temperature control unit determines whether the temperature measured exceeds a predetermined threshold value. A signal processing unit reduces a number of lines used in the plurality of transmission lines when the temperature measured exceeds the predetermined threshold value and transmits video data accordingly.

### BACKGROUND OF THE INVENTION

### 1. Field of the Invention

The present invention relates to an imaging technology for shooting video and transmitting the video via a plurality of transmission lines.

### 2. Description of the Related Art

In on-vehicle cameras and medical cameras, discrete-type imaging devices in which a camera head and a camera control unit are connected by a plurality of transmission lines are used. In shooting high resolution and high frame rate video for signal processing, the temperature of the camera head may become high. This is generally addressed by shutting down the power source forcibly so as to protect the device. In imaging environments in which on-vehicle cameras or medical cameras are used, however, suspension of a video output during use might result in unexpected outcomes that affect security or life.

Patent document 1 discloses an electronic camera capable of maintaining minimum operation even when the temperature is high, by limiting the camera operation depending on the temperature of the camera unit. Patent document 2 discloses an imaging device capable of continuing to record video as much as possible even when the temperature measured in the camera is increased.

[patent document 1] JP2007-28425
[patent document 2] JP2012-165373

One of the generally known problems with cameras is that, when the temperature of the camera becomes high, the power source is shut down so that it is difficult to continue to shoot images. In discrete-type imaging devices, there is called for a measure applicable to signal processing in the camera head when the temperature inside the camera head connected to the camera control unit via a plurality of transmission lines becomes high.

### SUMMARY OF THE INVENTION

The present invention addresses this issue and a purpose thereof is to provide an imaging technology capable of maintaining a video output even when the temperature of the camera head becomes high.

The imaging device (10) according to an embodiment of the present invention is adapted to shoot video and transmit the video via a plurality of transmission lines (200), and comprises: a temperature sensor (40) that measures a temperature of an imaging device; a decision unit (50) that determines whether the temperature measured exceeds a predetermined threshold value; and a signal processing unit (30) that reduces a number of lines used in the plurality of transmission lines when the temperature measured exceeds the predetermined threshold value and transmits video data accordingly.

Another embodiment of the present invention relates to an imaging method. The imaging method is adapted to shoot video and transmit the video via a plurality of transmission lines, and comprises: measuring a temperature of an imaging device; determining whether the temperature measured exceeds a predetermined threshold value; and reducing a number of lines used in the plurality of transmission lines when the temperature measured exceeds the predetermined threshold value and transmitting video data accordingly.

Optional combinations of the aforementioned constituting elements, and implementations of the invention in the form of methods, apparatuses, systems, recording mediums, and computer programs may also be practiced as additional modes of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram of a discrete-type imaging device according to an embodiment;

FIGS. 2A and 2B illustrate progressive processing during normal use;

FIGS. 3A and 3B illustrate interlace processing performed when the temperature is high;

FIGS. 4A and 4B illustrate interlace processing performed when the temperature is high;

FIGS. 5A, 5B and 5C illustrate a method of restricting the number of lines used in the plurality of transmission lines by lowering the frame rate;

FIGS. 6A, 6B and 6C illustrate a method of defining distinctive regions in an image;

FIGS. 7A, 7B, 7C and 7D illustrate a method of configuring the resolution in the peripheral portion to be lower than the resolution at the central portion;

FIGS. 8A and 8B illustrate a process of transmitting an image in the central portion and an image in the peripheral portion separately in different resolutions and

FIGS. 9A, 9B and 9C illustrate a process of transmitting an image in the central portion and an image in the peripheral portion separately in different color/gray tones.

### DETAILED DESCRIPTION OF THE INVENTION

The invention will now be described by reference to the preferred embodiments. This does not intend to limit the scope of the present invention, but to exemplify the invention.

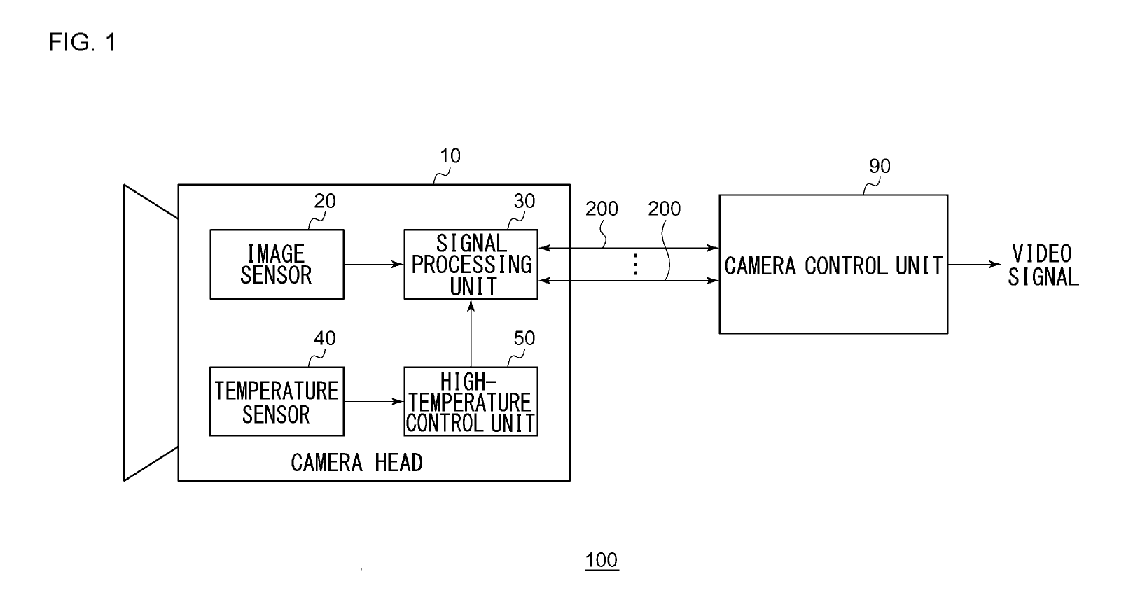

FIG. 1 is a block diagram of a discrete-type imaging device 100 according to an embodiment. The flow of signals between constituting elements of the discrete-type imaging device 100 will be described with reference to the figure.

The discrete-type imaging device 100 is provided with a camera head 10 and a camera control unit 90. The camera head 10 and the camera control unit 90 are connected by a plurality of transmission lines 200 for transmitting video signals.

Because the camera head 10 is discrete from the camera control unit 90, the camera head 10 can be located at a position remote from the camera control unit 90 or can be moved closer to the object of shooting. The discrete-type imaging device 100 is exemplified by an endoscope camera or an on-vehicle camera but the application of the inventive technology is not limited to these cameras.

The camera head 10 includes an image sensor 20, a signal processing unit 30, a temperature sensor 40, and a high-temperature control unit 50, which corresponds to a decision unit. The image sensor 20 forms an image of light from the object of shooting on an imaging device, using an optical system such as a lens. The image sensor 20 converts the light into an electrical signal by photoelectric conversion. The signal processing unit 30 subjects an electrical signal sequentially read from the image sensor 20 to signal processing so as to generate video data and transmit the video data by using a plurality of transmission lines 200.

The video data captured by the camera head 10 is transmitted to the camera control unit 90 via the plurality of transmission lines 200. In particular, in the case of high-resolution video such as 4K or 8K video, it is difficult to transmit the video data via a single transmission line so that a plurality of transmission lines 200 are required. For example, the number of transmission lines 200 may be eight. The video data on eight lines is sequentially read from the image sensor 20 of the camera head 10 and distributed line by line in eight transmission lines for transmission. The number of transmission lines 200 is not limited to eight.

The temperature sensor 40 measures the temperature of the camera head 10 and supplies a measurement result to the high-temperature control unit 50. If the measured temperature exceeds a predetermined threshold value, the high-temperature control unit 50 directs the signal processing unit 30 to perform “transmission line control” for reducing the number of lines used in the plurality of transmission lines 200. When the signal processing unit 30 is directed by the high-temperature control unit 50 to perform “transmission line control,” the signal processing unit 30 removes some of the plurality of transmission lines 200 from use and reduces power consumption by ensuring that the amount of signal processing is less than usual according to the method described later. By reducing power consumption, the temperature of the camera head 10 is lowered so that imaging can continue.

The camera control unit 90 receives video data from the plurality of transmission lines 200 and performs camera signal processing such as noise elimination, white balancing, gamma correction, YC separation, gain adjustment, etc. and outputs a video signal.

A description will be given of some examples of “transmission line control” performed by the signal processing unit 30 of the camera head 10.

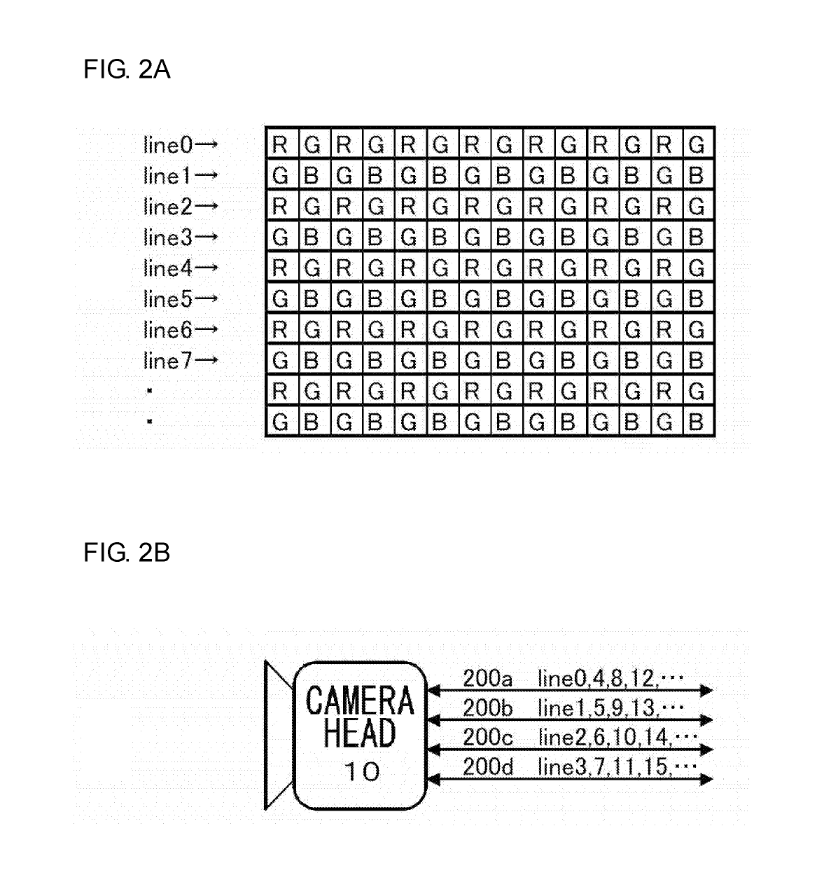

A description will be given, with reference to FIGS. 2-4, of a method of restricting the number of lines used in the plurality of transmission lines 200 by switching from progressive processing to interlace processing.

FIGS. 2A and 2B illustrate progressive processing during normal use. FIG. 2A schematically shows an arrangement of RGB pixels in an image captured by the image sensor 20. FIG. 2B shows how the data read line by line from the image of FIG. 2A is transmitted by using the plurality of (in this case, four) transmission lines 200 of the camera head 10. When the temperature of the camera head 10 has a predetermined threshold value or less, progressive processing is performed. The signal processing unit 30 reads image data for four lines from the image sensor 20 and transmits the image data by using four transmission lines 200.

At a first point of time for transmission, the four lines 0, 1, 2, and 3 are transmitted via the first, second, third, and fourth transmission lines 200a, 200b, 200c, and 200d. At a next point of time for transmission, the four lines 4-7 are transmitted via the first through fourth transmission lines 200a-200d. So long as the temperature of the camera head 10 has a predetermined threshold value or less, the image is sequentially read four lines at a time in progressive processing and is transmitted by using all of the four transmission lines 200a-200d.

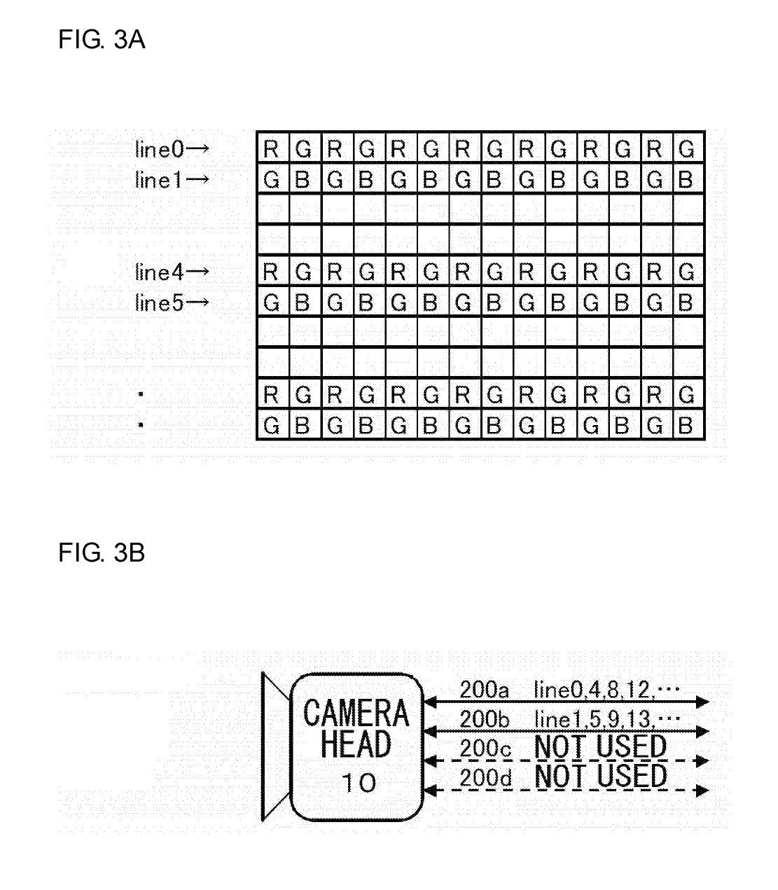

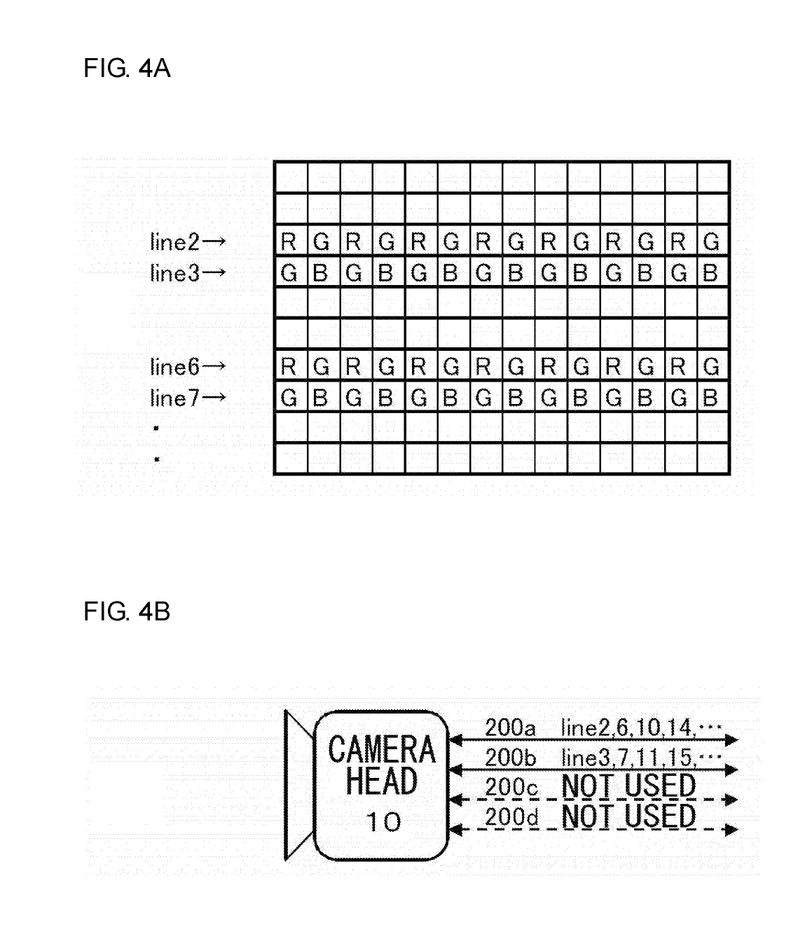

FIGS. 3A, 3B, 4A, and 4B illustrate interlace processing performed when the temperature is high. FIGS. 3A and 3B show how odd-numbered fields are processed in the interlace scheme, and FIGS. 4A and 4B show how even-numbered fields are processed in the interlace scheme. When the temperature of the camera head exceeds a predetermined threshold value, the high-temperature control unit 50 directs the signal processing unit 30 to switch from progressive processing to interlace processing.

As shown in FIGS. 3A and 3B, odd-numbered fields are read in the interlace scheme such that the lines 0 and 1 are read, the lines 2 and 3 are skipped, and then the lines 4 and 5 are read. At a first point of time for transmission, the lines 0 and 1 are transmitted via the first and second transmission lines 200a and 200b. At a next point of time for transmission, two lines are skipped, and the lines 4 and 5 are transmitted via the first and second transmission lines 200a and 200b, respectively.

As shown in FIGS. 4A and 4B, even-numbered fields are read in the interlace scheme such that the lines read in the odd-numbered fields of FIGS. 3A and 3B are skipped and the lines not read in the odd-numbered fields are read. In other words, the lines 0 and 1 are skipped and the lines 2 and 3 are read. The lines 4 and 5 are skipped and the lines 6 and 7 are read. At the first point of time for transmission, the lines 2 and 3 are transmitted via the first and second transmission lines 200a and 200b, respectively. At the next point of time for transmission, two lines are skipped and the lines 6 and 7 are transmitted via the first and second transmission lines 200a and 200b, respectively.

In interlace processing, interlace scanning as described above is performed to read two lines and transmit them by using only two transmission lines 200a and 200b. The other two transmission lines 200c and 200d are not used so that the power required to drive the transmission lines 200 can be reduced. The volume of signal processing in interlace processing is half as much as that of progressive processing so that the power required for signal processing can also be reduced.

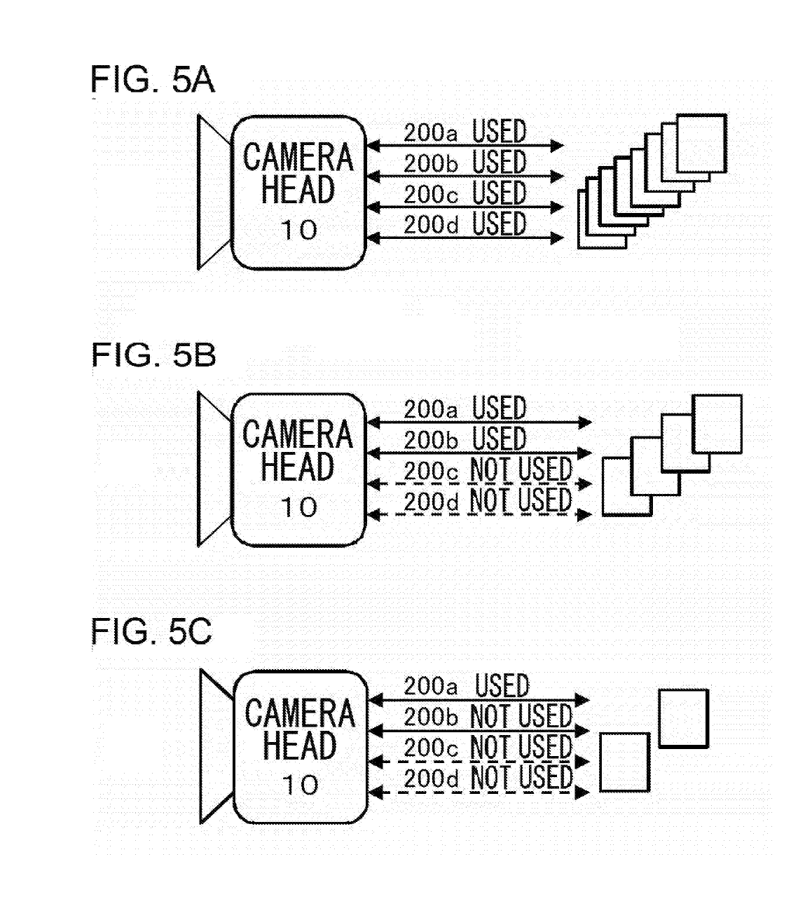

A description will now be given, with reference to FIGS. 5A and 5B, of a method of restricting the number of lines used in the plurality of transmission lines 200 by lowering the frame rate.

FIG. 5A illustrates a process of transmitting video at a high frame rate during normal use. When the temperature of the camera head 10 has a first threshold value or less, 60 frames per second (fps) video is transmitted by using all of the four transmission lines 200a-200d.

FIG. 5B illustrates a process of transmitting video at a lower frame rate when the temperature is higher. When the temperature of the camera head 10 exceeds a first threshold value but is not more than a second threshold value (the second threshold value is larger than the first threshold value), the frame rate of the video is lowered to 30 fps and the video is transmitted by using only the two transmission lines 200a and 200b. The other two transmission lines 200c and 200d are not used.

FIG. 5C illustrates a process of transmitting video at a still lower frame rate when the temperature is still higher. When the temperature of the camera head 10 exceeds the second threshold value, the frame rate of the video is lowered to 15 fps and the video is transmitted by using only one transmission line 200a. The other three transmission lines 200b, 200c, and 200d are not used.

Thus, by ensuring that the higher the temperature of the camera head 10, the lower the frame rate of the video so as to reduce the number of transmission lines 200 used accordingly, power consumption can be reduced in accordance with the temperature of the camera head 10. This is because the drive power is reduced by reducing the number of transmission lines used and the power required for signal processing is also reduced by lowering the frame rate.

A description will now be given of a method of restricting the number of lines used in the plurality of transmission lines 200, by defining distinctive regions in an image and controlling the image quality accordingly.

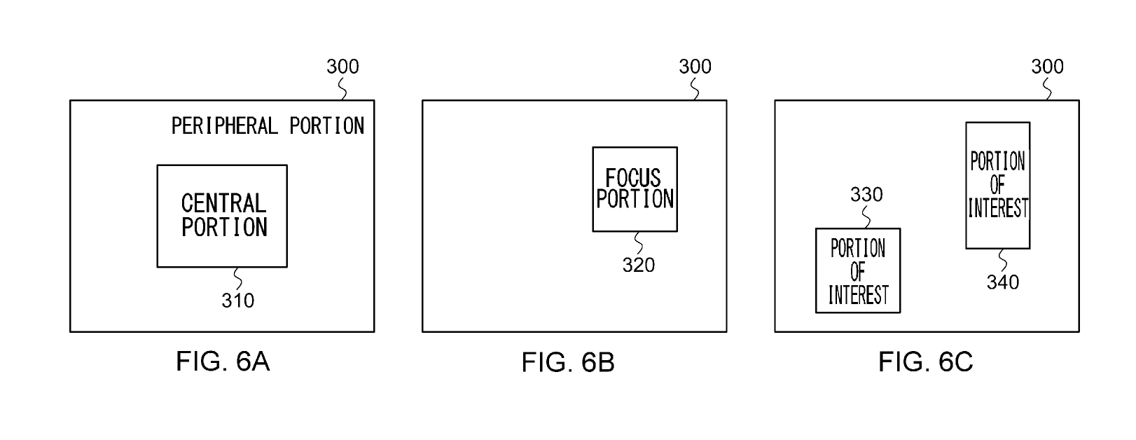

FIGS. 6A-6C illustrate a method of defining distinctive regions in an image. In FIG. 6A, a central portion 310 is defined in an image 300 in distinction from a peripheral portion other than the central portion 310. In FIG. 6B, a focus portion 320 where the object of shooting in focus is located is defined in the image 300 in distinction from the regions other than the focus portion 320. In FIG. 6C, two portions of interest 330 and 340 are defined in the image 300 in distinction from the regions other than the two portions of interest 330 and 340. The number of portions of interest is arbitrary. To describe it in more general terms, an image is segmented into “a specified region” and “a non-specified region.”

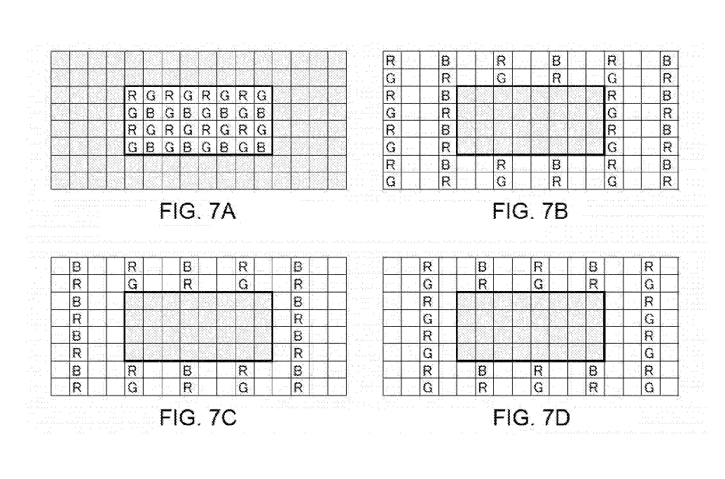

FIGS. 7A-7D illustrate a method adapted to distinguishing between the central portion and the peripheral portion in FIG. 6A, whereby the resolution in the peripheral portion is configured to be lower than the resolution in the central portion. FIG. 7A shows an image in the central portion. The resolution is the same as that of the original image. FIG. 7B shows a thinned-out image (referred to as an image for a peripheral portion A) obtained by selecting data at every third column, i.e., the first, fourth, and seventh column, in the peripheral portion. Similarly, FIG. 7C shows a thinned-out image (referred to as an image for a peripheral portion B) obtained by selecting data at every third column, i.e., the second, fifth, and eighth column, in the peripheral portion. FIG. 7D shows a thinned-out image (referred to as an image for a peripheral portion C) obtained by selecting data at every third column, i.e., the third, sixth, and ninth column, in the peripheral portion. The resolution of the images of the peripheral portions A, B, and C is ⅓ the resolution of the original image. The image in the peripheral portion is obtained at the resolution of the original image by combining the images of the three peripheral portions A, B, and C.

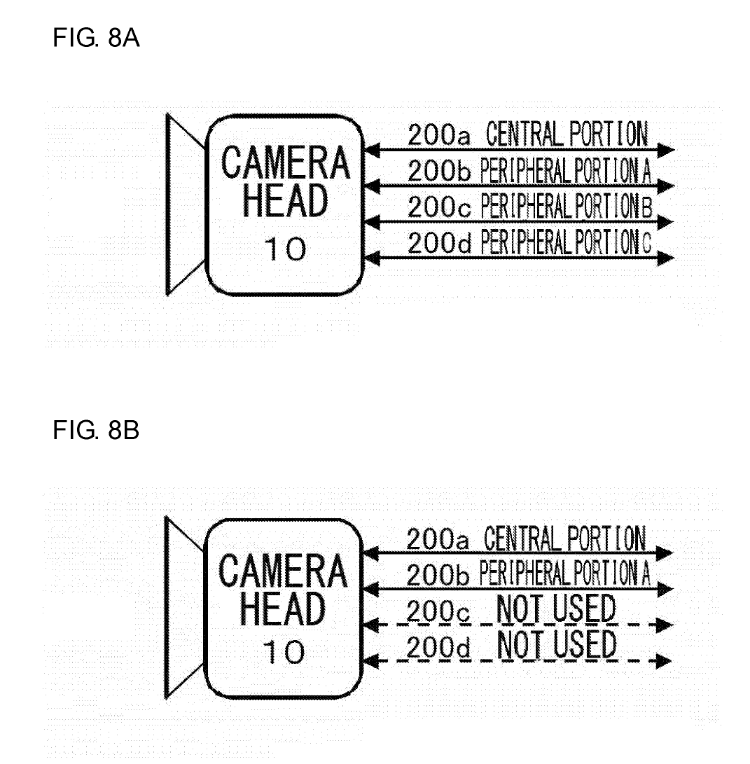

FIG. 8A illustrates a process of transmitting an image in the central portion and an image in the peripheral portion separately during normal use. When the temperature of the camera head 10 has a predetermined threshold value or less, the image in the central portion of FIG. 7A is transmitted via the first transmission line 200a. The images in the peripheral portions A, B, and C of FIGS. 7B, 7C, and 7D are transmitted via the second, third, and fourth transmission lines 200b, 200c, and 200d, respectively. As a result, the image as a whole is transmitted to the camera control unit 90 at the original resolution.

FIG. 8B illustrates a process of transmitting an image in the central portion and an image in the peripheral portion separately when when the temperature is high. When the temperature of the camera head 10 exceeds a predetermined threshold value, the image in the central portion of FIG. 7A is transmitted via the first transmission line 200a. The image in the peripheral portion A of FIG. 7B is transmitted via the second transmission line 200b. The images of the peripheral portions B and C of FIGS. 7C and 7D are not transmitted and the third and fourth transmission lines 200c and 200d are not used. In this case, the resolution of the image in the central portion is the same as that of the original image, but the resolution of the image in the peripheral portion is ⅓ the resolution of the original image.

In FIGS. 7A-7D, the resolution of the peripheral portion of the image is configured to be lower than the resolution of the central portion. Alternatively, the volume of information may be reduced by compressing the peripheral portion and not compressing the central portion. During normal use, both the central portion and the peripheral portion are uncompressed and transmitted by using all of the transmission lines 200. When the temperature is high, the central portion remains uncompressed and only the peripheral portion is compressed so that the number of transmission lines 200 used can be reduced.

In an alternative method, the volume of information in the peripheral portion may be reduced by decreasing the number of color/gray tones in the peripheral portion of the image than in the central portion. The entire bits in the central portion are transmitted. In the peripheral portion of the image, however, the high-order bits, middle-order bits, and low-order bits are transmitted separately.

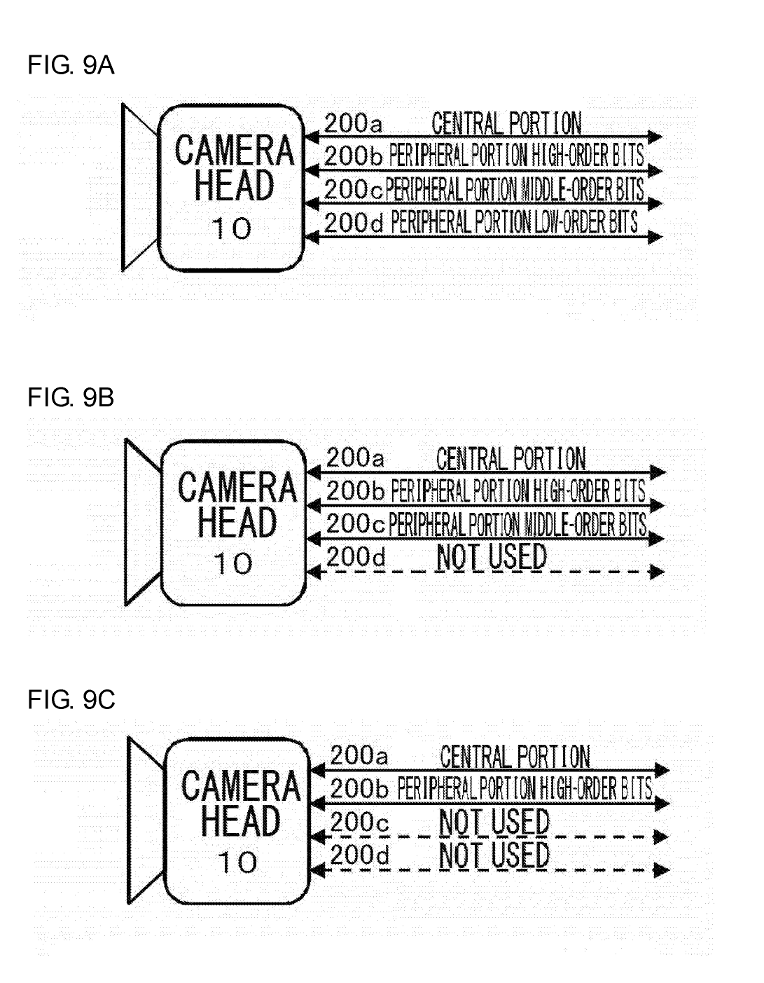

As shown in FIG. 9A, the image in the central portion is transmitted via the first transmission line 200a, and the high-order bits, middle-order bits, and low-order bits of the image in the peripheral portion are transmitted via the second, third, and fourth transmission lines 200b, 200c, and 200d, respectively, during normal use. During normal use, the number of tones of the image in the peripheral portion is the same as the number of tones of the original image.

As shown in FIG. 9B, the image in the central portion is transmitted via the first transmission line 200a, and the high-order bits and middle-order bits of the peripheral portion are transmitted via the second and third transmission lines 200b and 200c, respectively, when the temperature is higher. The low-order bits of the peripheral portion are not transmitted and the fourth transmission line 200d is not used. When the temperature is higher, the number of tones of the image in the peripheral portion is ⅔ the number of tones of the original image.

As shown in FIG. 9C, the image in the central portion is transmitted via the first transmission line 200a and only the high-order bits of the peripheral portion are transmitted via the second transmission line 200b, when the temperature is still higher. The middle-order bits and low-order bits of the peripheral portion are not transmitted and the third and fourth transmission lines 200c and 200d are not used. When the temperature is still higher, the number of tones of the image in the peripheral portion is ⅓ the number of tones of the original image.

By decreasing the number of tones of the peripheral portion in stages as the temperature of the camera head 10 becomes high and reducing the number of transmission lines 200 used in stages accordingly, power consumption can be reduced in accordance with the temperature of the camera head 10.

The description above illustrates a case in which an image is segmented into the central portion and the peripheral portion. The process described above can also be applied to a case shown in FIG. 6B in which the image is segmented into the focus portion and the other regions, or to a case in which the image is segmented into the portions of interest and the other regions. By using a high resolution in the focus portion or the portions of interest and using a low resolution in the other regions, the number of transmission lines 200 used can be reduced as the image in the peripheral portion at the low resolution is transmitted when the temperature is higher. By not compressing the focus portion or the portions of interest and compressing the other regions, the number of transmission lines 200 used can be reduced as the compressed image in the peripheral portion is transmitted when the temperature is higher. By using a larger number of tones in the focus portion or the portions of interest and using a smaller number of tones in the other regions, the number of transmission lines 200 used can be reduced as the image in the peripheral portion in a smaller number of tones is transmitted when the temperature is higher.

As described above, by using a certain scheme of reducing the processing volume when the temperature is high, the volume of data transmitted to the camera control unit 90 is reduced so that the number of transmission lines 200 used can be reduced and the drive power can be reduced.

As described above, according to the discrete-type imaging device 100 of the embodiment, it is possible to continue shooting images without interrupting a video output, by exercising transmission line control of reducing the number of transmission lines 200 used when the temperature is high, aside from the fact that the image quality is degraded when the temperature is high as compared to that of normal use. The imaging device 100 remains safe to use even in a situation where suspension of a video output represents a safety concern. Especially, it is difficult to exhaust air from an endoscope and the temperature inside the camera head is likely to be high. According to the transmission line control of the embodiment, it is possible to continue shooting images while also preventing the temperature from becoming high.

Described above is an explanation based on an exemplary embodiment. The embodiment is intended to be illustrative only and it will be obvious to those skilled in the art that various modifications to constituting elements and processes could be developed and that such modifications are also within the scope of the present invention.

The functions and components of the device described in the embodiment are implemented by hardware resources or software resources or the coordination of hardware resources and software resources. A processor, ROM, RAM, and other LSIs can be used as hardware resources. Programs such as operating systems, application programs can be used as software resources.

What is claimed is:

1. An imaging device adapted to shoot video and transmit the video via a plurality of transmission lines, comprising:
a temperature sensor that measures a temperature of an imaging device;
a decision unit that determines whether the temperature measured exceeds a predetermined threshold value; and
a signal processing unit that reduces a number of lines used in the plurality of transmission lines when the temperature measured exceeds the predetermined threshold value and transmits video data accordingly.

2. The imaging device according to claim 1, wherein
the signal processing unit reduces the number of lines used in the plurality of transmission lines by switching from a progressive scheme to an interlace scheme to process the video.

3. The imaging device according to claim 1, wherein
the signal processing unit reduces the number of lines used in the plurality of transmission lines by lowering a frame rate of the video.

4. The image device according to claim 1, wherein
the signal processing unit reduces the number of lines used in the plurality of transmission lines by segmenting the video into a specified region and a non-specified region and using a lower resolution or a smaller number of color/gray tones in the non-specified region than in the specified region.

5. The image device according to claim 1, wherein
the signal processing unit reduces the number of lines used in the plurality of transmission lines by segmenting video into a specified region and a non-specified region, and by not compressing the specified region and compressing the non-specified region.

6. An imaging method adapted to shoot video and transmit the video via a plurality of transmission lines, comprising:
measuring a temperature of an imaging device;
determining whether the temperature measured exceeds a predetermined threshold value; and
reducing a number of lines used in the plurality of transmission lines when the temperature measured exceeds the predetermined threshold value and transmitting video data accordingly.

7. A computer-readable recording medium having embodied thereon an imaging program adapted to shoot video and transmit the video via a plurality of transmission lines, the imaging program comprising:
a module to measure a temperature of an imaging device;
a module to determine whether the temperature measured exceeds a predetermined threshold value; and
a module to reduce a number of lines used in the plurality of transmission lines when the temperature measured exceeds the predetermined threshold value and transmit video data accordingly.
